(19) United States
(12) Patent Application Publication
(10) Pub. No.: US 2015/0138632 A1
(43) Pub. Date: May 21, 2015

(54) SLIDE TRAY AND RECEPTOR FOR MICROSCOPIC SLIDES AND METHOD OF OPERATION

(71) Applicant: Huron Technologies International Inc., Waterloo (CA)

(72) Inventor: Serguei Mikhailov, Mississauga (CA)

(21) Appl. No.: 14/402,023

(22) PCT Filed: May 17, 2013
(86) PCT No.: PCT/CA2013/000487

§ 371 Date: Nov. 18, 2014

Related U.S. Application Data
(60) Provisional application No. 61/649,073, filed on May 18, 2012.

(51) Int. Cl. G02B 21/26; G01N 21/13

(52) U.S. Cl. CPC G02B 21/26; G01N 21/13
USPC 359/391

(57) ABSTRACT

A receptor is mounted on a movable stage of a microscope slide scanner, the receptor being sized and shaped to receive a slide tray having one or more microscope slides thereon. A docking station automatically locks the receptor relative to the docking station whenever a tray is inserted or removed from the receptor without transmitting force to the movable stage.

### BACKGROUND OF THE INVENTION

1. Field of the Invention

This invention relates to the field of scanning tissue specimens on microscope slides, with particular emphasis on instrumentation and methods of changing slide trays manually, or automatically using a robotic manipulator. More particularly, this invention relates to a slide tray, receptor and docking station in which the slide tray can be manually or automatically inserted into or removed from the receptor, which is mounted on a moving stage of a microscope slide scanner.

2. Background of the Invention

Two general types of microscope slide loaders are known. Some slide loaders are designed for loading slides onto standard microscopes (for example the Prior Scientific PL-100) and some slide loaders integrated into pathology scanners (for example Aperio ScanScope AT) place microscope slides onto the microscope stage or insert them into the optical path. These slide loaders have the advantage of being small in size and able to handle large numbers of standard microscope slides. Disadvantages include problems that may occur when a slide breaks and the loader continues to load slides, and difficulty in handling large slides or mixing slide sizes. A second type of slide loader handles slide trays containing one or more slides, with the advantage that the slides themselves are not handled during movement of the trays, and multiple slides can be loaded into a single tray. The size of slides that can be handled is limited only by the size of the tray (our autoloader handles slide trays containing slides up to 6×8 inches in size), and slide sizes can be mixed in a single run or even in a single tray.

### OBJECTS OF THE INVENTION

It is an object of this invention to provide a slide tray, receptor and docking station such that a slide tray can be manually or automatically inserted into or removed from a receptor mounted on the moving stage of a slide-scanning microscope without transmitting force to the moving stage during insertion or removal of the slide tray.

It is an object of this invention to provide a slide tray, receptor and docking station such that a slide tray can be manually or automatically inserted into the receptor (which is mounted on the moving stage of a scanning microscope) for acquisition of a preview image. The slide tray can then be removed from the receptor, and then re-inserted into the receptor at a later time for a final scan of the specimen on the microscope slide, in which the placement of the slide on the microscope stage is substantially the same after each insertion.

It is a further object of this invention to provide a slide tray and receptor such that a slide tray can be manually or automatically re-inserted into the receptor (which is mounted on the moving stage of a slide-scanning microscope) for acquisition of a second image of the specimen, where the placement of the slide tray in the receptor (and thus the position of the slide on the microscope stage) is substantially the same after each insertion.

It is a further object of this invention to provide a slide tray containing a permanently-mounted test and/or calibration specimen that can be used for transmission and/or reflection imaging.

### SUMMARY OF THE INVENTION

A slide tray and receptor in combination is used with one or more microscope slides located in a microscope slide scanner, the slide tray comprising an opening to removably receive the microscope slide. The receptor comprises a receiving portion that is sized and shaped to receive the tray, the receptor having at least one retainer to removably retain the tray in position when the tray is inserted into the receptor. The receptor is affixed to a movable stage of the slide scanner, the slide tray being located in substantially the same position in the receptor each time that the tray is inserted into the receptor.

A slide tray, receptor and docking station in combination is used with one or more microscope slides located in a microscope slide scanner, the slide tray comprising an opening to removably receive a microscope slide. The receptor comprises a receiving portion that is sized and shaped to receive the tray, the receptor having at least one retainer to removably retain the tray in position for scanning the microscope slide when the tray is inserted into the receptor. The receptor is affixed to a movable stage of the slide scanner, the slide tray being mounted in substantially the same position in the receptor each time that it is inserted into the receptor. The receptor has at least one locking area, the locking area being sized and located to removably receive a lock located on the docking station to lock the receptor relative to the docking station when the tray is inserted into or removed from the receptor. The slide scanner has a controller to control operation of the tray, receptor and docking station so that the movable stage is not subject to external forces as a tray is inserted or removed from the receptor.

A slide tray for insertion into a receptor is used with one or more microscope slides located in a microscope slide scanner, the slide tray comprising a permanently-mounted test and/or calibration specimen that can be used for transmission and/or reflection imaging.

A method of inserting or removing slide trays from a receptor is provided, the slide trays having one or more microscope slides and being located in a microscope slide scanner. The method comprises locating a receptor on a movable stage of the slide scanner, operating a docking station to releasably lock the receptor relative to the docking station whenever a tray is inserted into or removed from the receptor without transmitting force to the moving stage during the insertion or removal of the slide tray.

### BRIEF DESCRIPTION OF THE DRAWINGS

FIG. 1a shows a preferred embodiment of a slide tray used in the present invention, showing the pins which interact with the spring locking mechanism to hold the slide tray in place in the slide tray receptor shown in FIG. 2, and a central insert to hold a large microscope slide.

FIG. 1b shows a slide tray with microscope slide mounted, as well as a test and calibration slide mounted near the positioning pins on the right side of the diagram.

FIG. 1b shows the outer frame of a slide tray like that shown in FIG. 1a, in which a slide-holding insert will be placed.

FIG. 2a is a perspective view of the slide tray receptor showing the spring locking mechanism used to keep the slide tray in place in the receptor.

FIG. 2b is a perspective view of the slide tray receptor of FIG. 2a with one spring locking mechanism disassembled to show its individual components.

FIG. 3 shows the docking station that holds the slide tray receptor in place during insertion or removal of the slide tray.

FIG. 4 shows the receptor mounted on the Z-stages that are part of a computer-controlled X-Y-Z-tilt microscope stage.

FIG. 5 shows a schematic front view of an X-Y-Z-tilt stage of a scanning microscope or macroscope.

### DESCRIPTION OF THE INVENTION

The present invention is a practical docking station, slide tray receptor and slide tray that enables a slide tray containing one or more microscope slides to be manually or automatically inserted into and removed from a slide tray receptor mounted on a computer-controlled microscope stage without transmitting force to the microscope stage during insertion or removal, and to be re-inserted into the receptor at substantially the same position relative to the microscope stage.

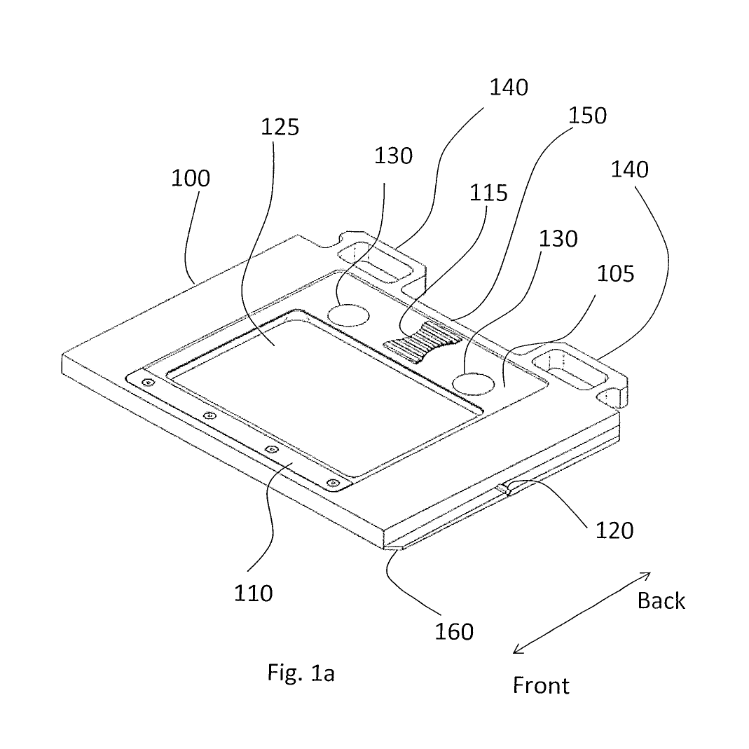

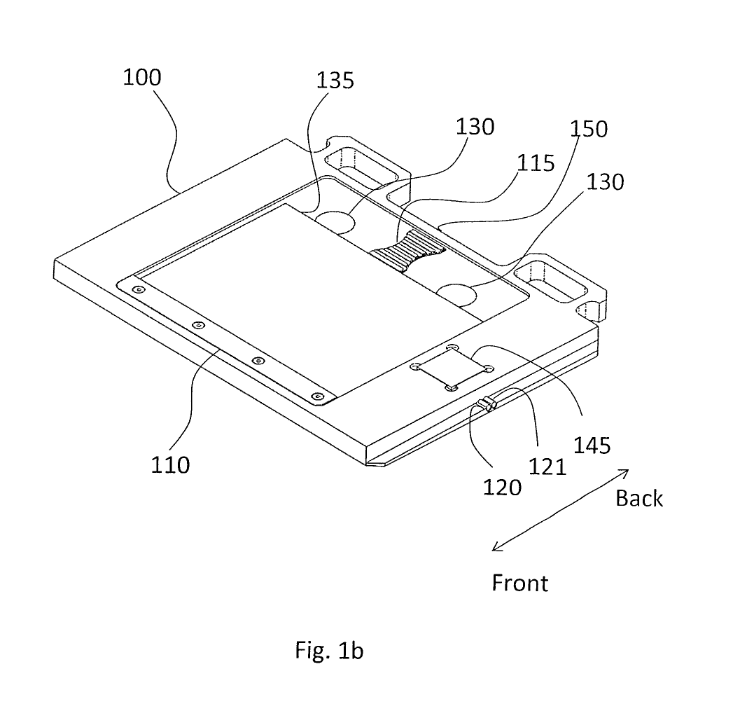

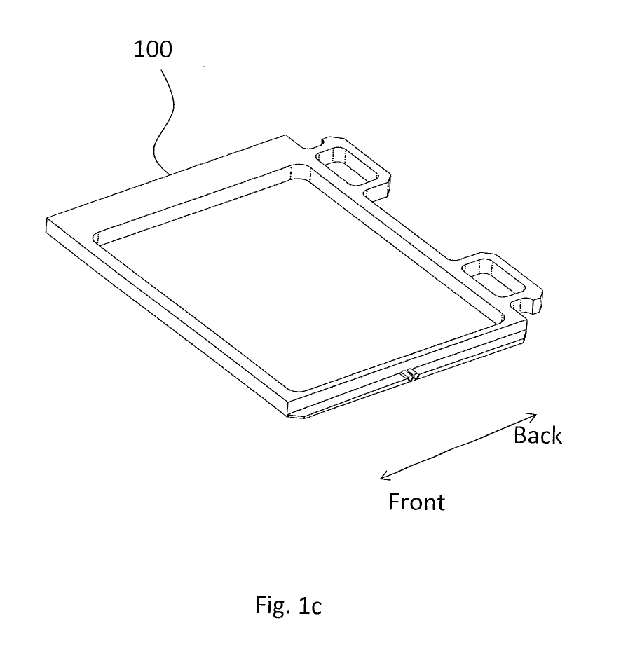

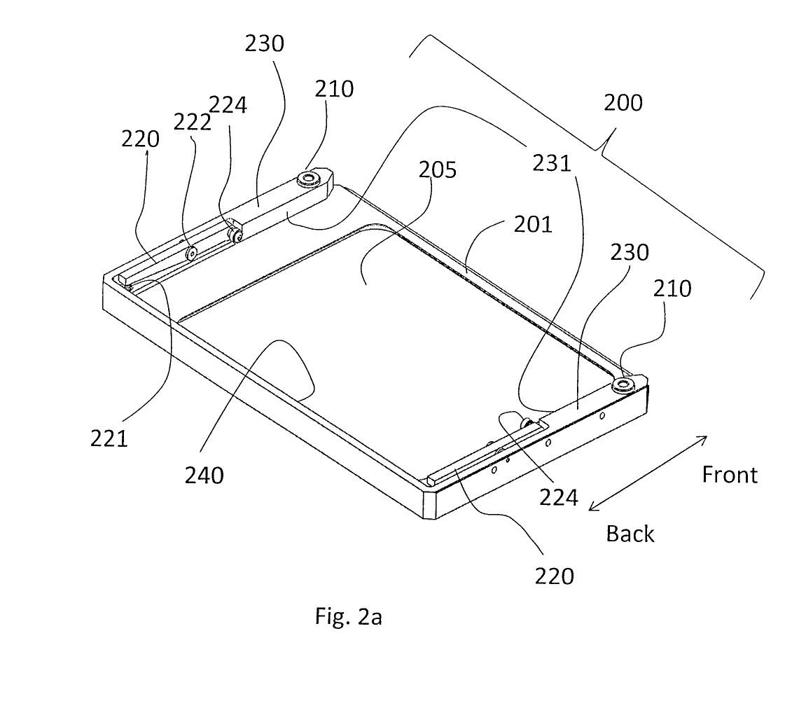

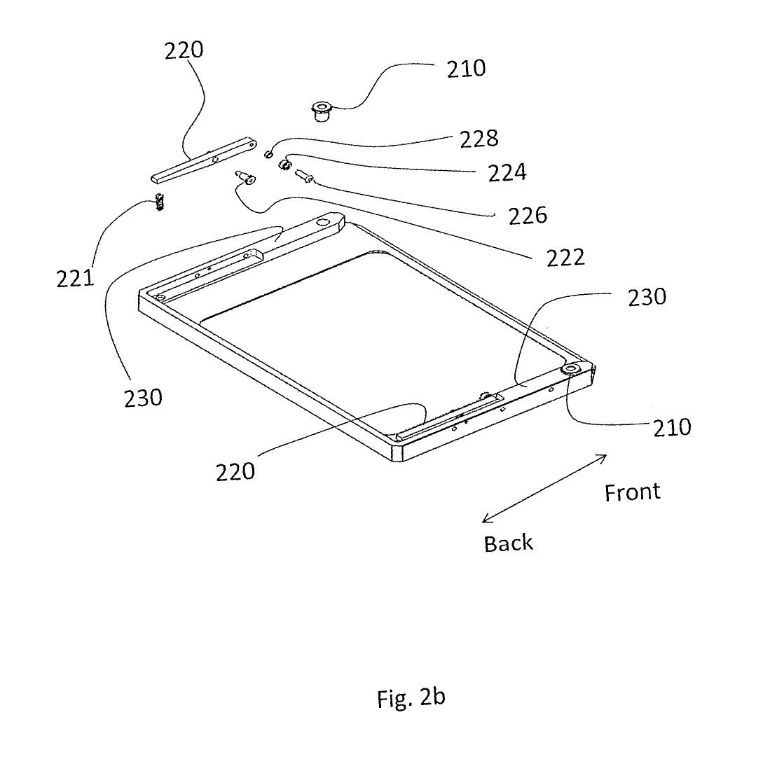

An example of a slide tray as used in the present invention is shown in FIG. 1a. A slide tray frame 100 contains a slide carrier 105 in which a microscope slide is placed, held against positioning plate 110 by a spring-loaded pusher 115. A wedge-shaped ramp 160 (on both sides of the slide tray frame 100) runs under a positioning roller 224 shown in FIG. 2a. The slide tray shown in this diagram is designed to hold one 4×5 inch microscope slide (which is not shown loaded into this tray) above an open window 125 allowing for both transmission and reflection imaging. Indentations 130 allow fingers to be inserted under the edge of the slide to assist in removing the slide from the tray. When a tray is designed to hold multiple smaller slides, a spring-loaded pusher 115 is provided for each slide. The slide trays are designed to hold multiple 1×3 inch slides, three 2×3 inch slides, one 4×5 inch slide, one 5×7 inch slide, and one 6×8 inch slide, and trays for other slide sizes can easily be designed. Handles 140 are used for either manual or robotic handling of the tray. A barcode 150 is permanently mounted on the back edge of the tray, and is a unique identifier for that tray. There are a plurality of trays (not shown) and each tray has its own barcode or other unique identifier. Trays of the plurality of trays can be successively mounted in the receptor as desired. In addition to describing the number, size and position of each slide in the tray, the operator can store information in a database indexed by the unique tray identifier which is accessible by the scanner's control and operating system. This information enables the scanner to automatically change lasers, filters, detectors and detector gain, etc. before scanning the slides in that tray. One positioning pin 120 is shown on the right side of the tray; one more pin is at the same position along the left edge of the tray (not shown). These pins are used to align and hold the tray in the receptor as described below in the description of FIG. 2a.

FIG. 1b shows a slide tray containing a permanently-mounted test and/or calibration slide 145 which is mounted above an open window (not shown) in the slide holder frame so either transmission or reflection test and/or calibration slides can be used. Slide trays containing test or calibration slides can be used for several different purposes, including calibrating the instrument (often done daily or before scanning a large number of similar slides); for standardizing fluorescence by measuring fluorescence from a well-characterized calibration slide; for testing instrument resolution; and many others. The barcode 150 on the back edge of the slide tray includes information describing the calibration and/or test slide mounted on that tray. FIG. 1b also shows a large microscope slide 135 in position in the slide tray, held against positioning plate 110 by pressure from spring loaded pusher 115. The edges of both positioning plate 110 and spring loaded pusher 115 that push on the slide are beveled to apply a downward force component to the edge of the slide. The positioning of indentations 130 relative to the edge of slide 135 allows a finger of a user to be inserted in one of the indentations to aid in removing the slide from the tray. The slide tray shown in FIG. 1b has two positioning pins (120 and 121) on each side of the tray. In this embodiment, the positioning rollers 224 shown in FIG. 2a roll over pin 120 and settle into the the space between pins 120 and 121 (the same thing happens on the other side of the tray), holding the tray in place. In this arrangement, the trays are held in position by the rollers pushing down on the two pins on each side of the tray. The tray and receptor can be designed with one retainer to retain the tray in the receptor other than the two retainers (i.e. pins 121).

A slide tray frame 100 for very large slides is shown in FIG. 1c, which has a window opening large enough to accommodate a slide carrier (not shown in this diagram) designed to hold one very large slide or several small slides.

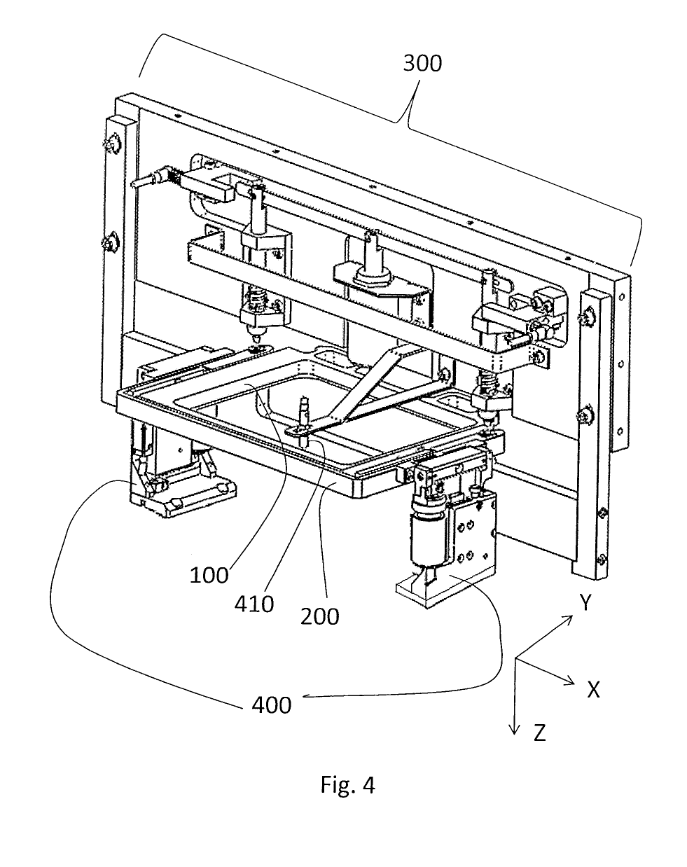

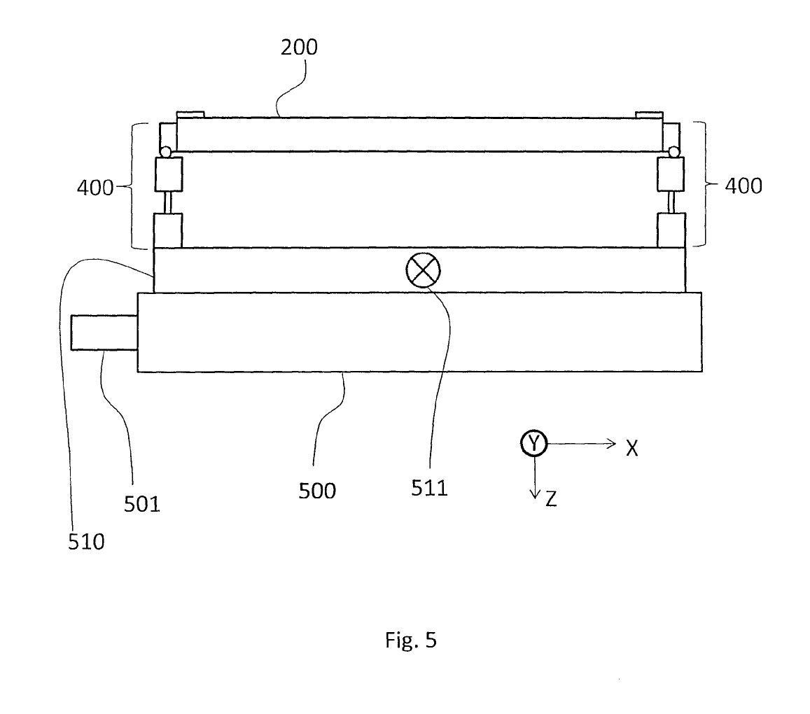

FIG. 2a shows a slide tray receptor 200 for receiving and holding a microscope slide tray like that shown in FIG. 1a or 1b. The slide tray receptor is a component of the microscope stage {i.e. the instrument is rigidly mounted to two Z-stages that enable focus and tilt on the scanner (see FIG. 4), part of the X-Y-Z-tilt stage (see FIG. 5)}. The slide tray receptor 200 is comprised of a frame 201 on which there are two guides 230 containing bushings 210 and two spring-loaded rocker arms 220 pivoted on axle 222 to push positioning rollers 224 downward. The arms 220 are spring-loaded by springs 221 (only one of which is shown). The arms 220 can be spring-loaded in various other ways, including a spring-loaded axle. When a slide tray like that shown in FIG. 1a is loaded from the open end of the receptor, it slides on the base plate of frame 201 between guide walls 231 and the wedge-shaped ramps 160 move under positioning rollers 224. When the tray is fully inserted, the positioning rollers pass over the pins just before full insertion of the slide tray, and the tray is held firmly by pressure from the rollers on single pins on each side of the tray holding the tray against end plate 240 at the back of slide tray receptor 200. When a slide tray like that shown in FIG. 1b is loaded, positioning rollers 224 pass over pin 120 on both sides of the tray, and the spring-loaded rollers settle down between and on top of pins 120 and 121 and these pairs of pins on both sides of the tray hold the tray in position. Two bushings 210 at the front of the slide tray receptor are used during docking as will be described later.

FIG. 2b shows an exploded view of the spring-loaded rocker arm on the left side of receptor 200. Rocker arm 220 pivots about axle 222, pushed by spring 221. At the other end of the rocker arm, roller 224 is mounted on axle 226 with spacer 228 holding the roller away from the end of the rocker arm. Bushing 210, which is inserted in the top of guide 230, is also shown.

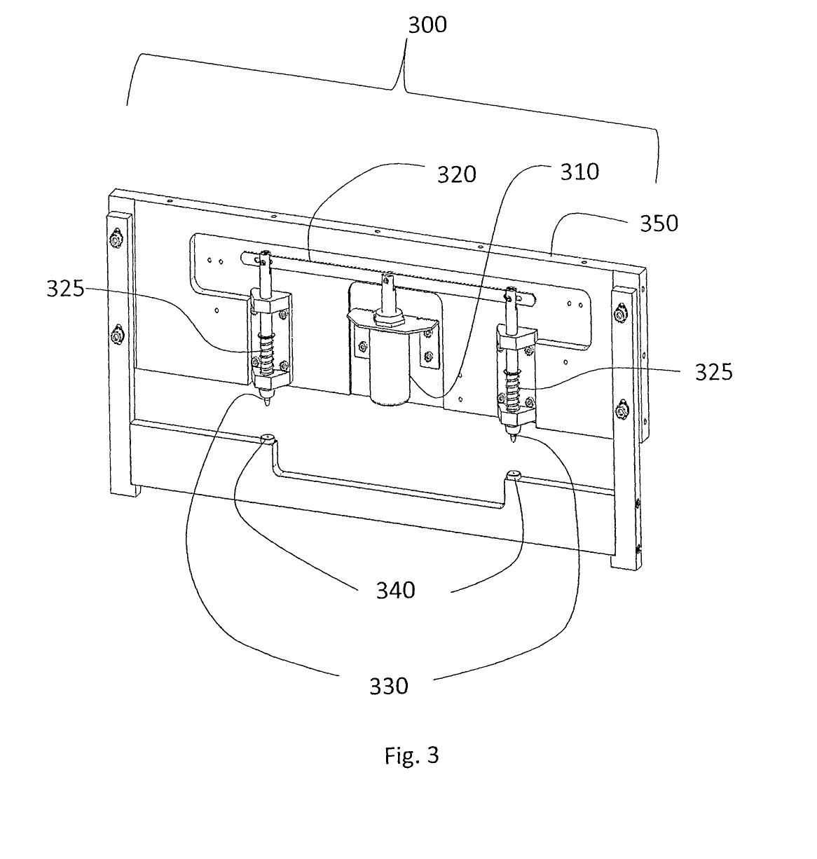

FIG. 3 shows a docking station 300 for holding the slide tray receptor firmly in place when inserting or removing a slide tray such that no force is transmitted to the microscope stage. When energized, solenoid 310 pulls control arm 320 downwards, compressing springs 325 and causing pins 330 to move downwards and be inserted into the bushings 210 at the front of tray receptor 200. At the same time, the front of tray receptor 200 is pushed down onto pads 340, and the tray receptor is held firmly by pins 330 and the pressure on pads 340. When solenoid 310 is turned off, springs 325 push control arm 320 upwards, retracting pins 330 and moving solenoid 310 back to its unenergized state. The frame 350 of docking station 300 is rigidly attached to the microscope frame (not shown in FIG. 3) to keep it from moving with respect to the microscope frame and stage during insertion and removal of a slide tray.

FIG. 4 shows the relative positions of docking station 300, slide tray receptor 200 {mounted on two Z-stages which can be used for specimen focus and tilt, which are themselves mounted on an X-Y stage (not shown)} and with an empty slide tray frame 100 in the fully inserted position. Optical sensor 410 confirms whether a slide tray is in the slide tray receptor or not.

When a slide tray is to be inserted or removed, a series of stage movements are made under computer control. First, the Z stages 400 level the tray receptor 200 and then move it vertically until the front edge of the receptor is just above pads 340 (which cannot be seen in this view). Next, the X and Y stages center the tray receptor so that bushings 210 at the front of receptor 200 are aligned with pins 330 in docking station 300. Solenoid 310 is energized, pulling pins 330 down into bushings 210 and pushing the bottom of receptor 200 against pads 340. At the same time, power is removed from the Z stages so that the receptor is now held firmly by the docking station, and no force is transmitted to the stages. If power is not removed from the Z stage, there is the possibility that the solenoid and Z stages will compete, which may cause the control program to shut down the stages. Depending on the motors used in the X and Y stages and the controller used, it may be necessary to remove power from these stage motors when docked, but in practice it has been found that this not necessary for the particular stages used. Optical sensor 410 confirms whether a slide tray is in the receptor. If a slide tray is in the receptor, it can now be removed either manually or using a robotic tray handler. If the optical sensor 410 does not find a tray in the receptor, one can now be loaded manually or by a robotic tray handler. After a new slide tray has been loaded, solenoid 310 is powered off, pins 340 retract, at the same time the Z stage is activated, and then the X, Y and two Z stages move the new specimen into position to start preview scanning, tissue finding, focusing, setting system gain, etc., and scanning. Because the combination of slide tray, slide tray receptor and docking station described in this patent have been designed so that a tray can be removed from the instrument and then loaded again with the specimen in substantially the same position relative to the microscope stage, when a number of slides are to be scanned in the same run using a robotic tray loader, the operator can perform a rapid preview of specimens on all of the slides, check to make sure focus and exposure are correct, and that instrument settings are correct for each slide, before starting batch scanning of a number of slide trays. This is particularly useful when a batch scan can take several hours, and can most conveniently be done overnight. The bushings 210 are each a locking area on the receptor. The pistons are locks to lock the receptor relative to the locking mechanism.

FIG. 5 shows a schematic front view of the X-Y-Z-tilt stage used in our instrument. Slide tray receptor 200 is attached to two positioners 400 that move in the Z direction. The focus of the microscope (or macroscope) is changed by moving these two positioners equal distances in the Z-direction, and the tilt of the slide tray receptor can be changed by moving only one positioner. The two positioners 400 are attached to a Y-stage 510 which is moved by Y-stage motor 511, and Y-stage 510 is mounted on an X-stage 500 which is moved by X-stage motor 501. In this diagram, the Y-direction is into the page. This combination comprises an X-Y-Z-tilt stage that is computer controlled when in operation.

Having described preferred embodiments of a new apparatus and method for changing slide trays in a Microscope Slide Scanner for imaging microscopic and macroscopic specimens, constructed in accordance with the present invention, it is believed that other modifications, variations, and changes will be suggested to those skilled in the art in view of the teachings set forth herein. It is therefore to be understood that all such variations, modifications, and changes are believed to fall within the scope of the present invention as defined by the appended claims.

1. A slide tray and receptor in combination for use with one or more microscope slides having specimens for imaging in a microscope slide scanner, the slide tray comprising an opening to removably receive the microscope slide, the receptor comprising a receiving portion that is sized and shaped to receive the tray, the receptor having at least one retainer to removably retain the tray in position when the tray is inserted into the receptor, the receptor being affixed to a movable stage of the slide scanner, the slide tray being located in substantially the same position in the receptor each time that the tray is inserted into the receptor.

2. A slide tray, receptor and docking station in combination for use with a microscope slide, the slide tray comprising an opening to removably receive a microscope slide, the receptor comprising a receiving portion that is sized and shaped to receive the tray, the receptor having at least one retainer to removably retain the tray in position for scanning the microscope slide when the tray is inserted into the receptor, the receptor having at least one locking area, the locking area being sized and located to removably receive a lock located on the docking station to lock the receptor relative to the docking station when the tray is inserted into or removed from the receptor.

3. The combination as claimed in claim 1 wherein the at least one retainer on the receptor is two retainers, one on each side of the receptor, the tray having pins on either side thereof to engage the retainers.

4. The combination as claimed in claim 3 wherein the two retainers are two spring mounted pivotal arms that interact with the pins to releaseably hold the slide tray in the receptor when the slide tray has been inserted.

5. The combination as claimed in claim 4 wherein there are a plurality of slide trays that are sized and shaped to be successively inserted and removed from the receptor, each slide tray having a unique identifier thereon.

6. The slide tray, receptor and docking station in combination for use with one or more microscope slides, having specimens for imaging in a microscope slide scanner, the slide tray comprising an opening to removably receive a microscope slide, the receptor comprising a receiving portion that is sized and shaped to receive the tray, the receptor having at least one retainer to removably retain the tray in position for scanning the microscope slide when the tray is inserted into the receptor, the receptor being affixed to a moveable stage of the slide scanner, the slide tray being mounted in substantially the same position in the receptor each time that it is inserted into the receptor, the receptor having at least one locking area, the locking area being sized and located to removably receive a lock located on the docking station to lock the receptor relative to the docking station when the tray is inserted into or removed from the receptor, the slide scanner having a controller to control operation of the tray, receptor and docking station so that the movable stage is not subject to external forces as a tray is inserted or removed from the receptor.

7. The combination as claimed in claim 6 wherein there are two locking areas, one on either side of the receptor, each locking area being a through hole there being two locks, one for each locking area.

8. The combination as claimed in claim 7 wherein there are plurality of trays and each tray is marked with a unique identifier to distinguish each tray from all of the remaining trays, the trays being inserted and removed from the receptor manually or automatically, there being a control system to lock the receptor relative to the docking station whenever a tray is either inserted or removed from the receptor without transmitting force to the movable stage.

9. The slide tray for insertion into a receptor for use with one or more microscope slides having specimens for imaging in a microscope slide scanner, the slide tray comprising a permanently-mounted test and/or calibration specimen can be used for transmission and/or reflection imaging.

10. A method of inserting or removing slide trays from a receptor, the slide trays having one or more microscope slides having specimens for imaging in a microscope slide scanner, the method comprising locating a receptor on a movable stage of the slide scanner, operating a docking station to releasably lock the receptor relative to the docking station whenever a tray is inserted into or removed from the receptor without transmitting force to the moving stage during the insertion or removal of the slide tray.
